(19) United States
(12) Patent Application Publication
(10) Pub. No.: US 2024/0291112 A1
(43) Pub. Date: Aug. 29, 2024

(54) RECHARGEABLE BATTERY MODULE

(71) Applicant: SAMSUNG SDI CO., LTD., Yongin-si (KR)

(72) Inventors: Heonhee KIM, Yongin-si (KR); Kum-Yul HWANG, Yongin-si (KR); Nohyun KWAG, Yongin-si (KR); Kwangsoo BAE, Yongin-si (KR)

(21) Appl. No.: 18/488,715

(22) Filed: Oct. 17, 2023

(30) Foreign Application Priority Data
Feb. 24, 2023 (KR) 10-2023-0025396

(51) Int. Cl. H01M 50/507; H01M 50/213; H01M 50/291; H01M 50/298; H01M 50/509; H01M 50/522

(52) U.S. Cl. CPC H01M 50/507; H01M 50/213; H01M 50/291; H01M 50/298; H01M 50/509; H01M 50/522

(57) ABSTRACT

A rechargeable battery module includes: a plurality of battery cells; a lower case accommodating lower ends of the battery cells; a holder case coupled to the lower case and accommodating the battery cells; a plurality of bus bars on the holder case; a plurality of bonding wires connecting the battery cells to the bus bars; and an upper case covering the bus bars and the bonding wires and coupled to the holder case.

### CROSS-REFERENCE TO RELATED APPLICATION

This application claims priority to and the benefit of Korean Patent Application No. 10-2023-0025396, filed in the Korean Intellectual Property Office on Feb. 24, 2023, the entire content of which is incorporated herein by reference.

### BACKGROUND

### 1. Field

Aspects of embodiments of the present disclosure relate to a rechargeable battery module.

### 2. Description of the Related Art

A rechargeable battery is designed to be repeatedly charged and discharged, unlike a primary battery. Small-capacity rechargeable batteries are used in portable electronic devices, such as mobile phones, notebook computers, and camcorders. Large-capacity and high-density rechargeable batteries are used to power for motor driving of hybrid vehicles and electric vehicles and energy storage.

A rechargeable battery may be used as a rechargeable battery module including a plurality of battery cells connected to each other in series and/or parallel to, for example drive a motor of a hybrid vehicle requiring relatively high energy density. For example, a rechargeable battery module may be formed by connecting electrode terminals of a plurality of battery cells together, with the number and connection arrangement of the battery cells corresponding to a desired voltage and current to implement a relatively high-output rechargeable battery module (e.g., for use in an electric vehicle).

A rechargeable battery module may include a pair of holders and may be accommodated in a case by fastening the pair of holders accommodating battery cells with a fastening member. Before fastening the pair of holders with the fastening member, the battery cells are connected with tabs.

Generally, A rechargeable battery module is designed for one or a small number of specific customers (or applications) and has a cell arrangement and configuration designed accordingly. Thus, when development of a rechargeable battery module having a cell configuration with different voltages and currents is requested, a separate module design using separate parts is developed and verification is required. This increases development and production costs.

### SUMMARY

Embodiments of the present disclosure provide a rechargeable battery module that can meet different voltage and current requirements of various modules with one design.

A rechargeable battery module, according to an embodiment of the present disclosure, includes: a plurality of battery cells; a lower case accommodating lower ends of the battery cells; a holder case coupled to the lower case and accommodating the battery cells; a plurality of bus bars on the holder case; a plurality of bonding wires connecting the battery cells to the bus bars; and an upper case covering the bus bars and the bonding wires and coupled to the holder case.

The bus bars may connect the battery cells through a plurality of serial connections and a plurality of parallel connections.

The battery cells may have a cylindrical shape, and three adjacent ones of the battery cells accommodated in the holder case may form an isosceles triangular arrangement.

A side of a first battery cell from among the three adjacent ones of the battery cells may form a first angle of 68° in the isosceles triangular arrangement, and sides of a second battery cell and a third battery cell from among the three adjacent ones of the battery cells may each form a second angle of 56° in the isosceles triangular arrangement.

A second battery cell and a third battery cell from among the three adjacent ones of the battery cells may face each other at a first angle at a side of a first battery cell from among the three adjacent ones of the battery cells and may have a first gap therebetween. The first battery cell and the second battery cell may have a second gap therebetween that is smaller than the first gap, and the first battery cell and the third battery cell may have the second gap therebetween.

The bus bars may include: a first member between the first battery cell and the second battery cell and extending along a first direction; and a second member between the first battery cell and the third battery cell and extending along the first direction.

The first member and the second member may be respectively at opposite sides of the first battery cell and may be spaced apart in a second direction crossing the first direction. The first member and the second member may be between the second battery cell and the third battery cell.

The first member and the second member may each have: a first straight portion extending in the first direction from opposite sides of the first battery cell; a second straight portion extending in the first direction between the second battery cell and the third battery cell; a third straight portion extending in the first direction between the first battery cell and the second battery cell and between the first battery cell and the third battery cell; a first inclined portion connecting the first straight portion and the third straight portion; and a second inclined portion connecting the second straight portion and the third straight portion.

The bus bar may be an aluminum alloy, may has a thickness of 0.5 mm, and may have a width of 4.0 mm.

The second straight portion of the first member and the second straight portion of the second member may have a third gap therebetween.

The third gap may be smaller than the first gap and greater than the second gap.

The bus bars may be fixed on the holder case by a double-sided adhesive tape.

The holder case may have a protrusion extending into a hole in the bus bars to fix the bus bars to the holder case.

The bus bars may be fixed to the holder case by insert molding.

The holder case may include a partition wall extending in a second direction crossing a first direction to divide the holder case into a plurality of sections in the first direction, and at least two of the bus bars at opposite sides of the partition wall along the first direction may be connected to each other by a bus bar bonding wire on the partition wall.

The partition wall may divide the battery cells into a first cell area and a second cell area along the first direction, and the bus bars may each include a first area member connecting the battery cells in the first cell area to each other and a second area member connecting the battery cells in the second cell area to each other.

The bus bar bonding wire may wire bond the first area member and the second area member.

The battery cells: may form a first module including a plurality of first serial connection groups and a plurality of second parallel groups with the first area member in the first cell area; may form a second module including a plurality of first serial connection groups and a plurality of second parallel groups with the second area member in the second cell area; and may form a module including a plurality of first double serial connections and a plurality of second parallel connections by wire bonding the first area member and the second area member with the bus bar bonding wire.

The battery cells: may form a first module having a 28s6p connection configuration by connecting 28 serial connection groups using 6 parallel groups with the first area member in the first cell area; may form a second module having a 28s6p connection configuration by connecting 28 serial connection groups using 6 parallel groups with the second area member in the second cell area; and may form a module having a 56s6p by wire bonding the first area member and the second area member with the bus bar bonding wire.

The holder case may include three partition walls extending in a second direction crossing a first direction to divide the holder case into four sections in the first direction, and four of the bus bars may be respectively in the four section at opposite sides of the three partition walls and may be connected by bus bar bonding wires on the partition walls.

A number of the battery cells may be 336, and the bonding wires and the bus bar bonding wire may connect the battery cells to form one of: a 1s336p module formed by 336 parallel connections; a 2s168p module formed by two serial connections and 168 parallel connections; a 3s112p module formed by 3 serial connections and 112 parallel connections; a 6s56p module formed by 6 serial connections and 56 parallel connections; a 12s28p module formed by 12 serial connections and 28 parallel connections; a 28s12p module formed by 28 serial connections and 12 parallel connections; a 56s6p module formed by 56 serial connections and 6 parallel connections; a 112s3p module formed by 112 serial connections and 3 parallel connections; a 168s2p module formed by 168 serial connections and 2 parallel connections; and a 336s1p modules formed by 366 serial connections.

The rechargeable battery module, according to embodiments of the present disclosure, may include a number of battery modules wire bonded to bus bars to provide various voltages and currents as desired.

In addition, according to embodiments of the present disclosure, the bus bars are formed into a first area member and the second area member in a longitudinal direction are wire-bonded or are not bonded by bonding wires (e.g., bus bar bonding wires) according to desired voltages and currents. Accordingly, the rechargeable battery module may reduce development and production costs.

### BRIEF DESCRIPTION OF THE DRAWINGS

FIG. 1 illustrates an exploded perspective view of a rechargeable battery module according to an embodiment of the present disclosure.

FIG. 2 illustrates a top plan view of the rechargeable battery module shown in FIG. 1 in which bus bars are installed.

FIG. 3 illustrates a top plan view of the rechargeable battery module shown in FIG. 1 showing the bus bars.

FIG. 4 illustrates a partial top plan view of the rechargeable battery module shown in FIG. 2 in which bus bars are installed.

FIG. 5 illustrates a top plan view geometrically showing a disposition of battery cells in the rechargeable battery module shown in FIG. 4.

FIG. 6 illustrates a cross-sectional view showing an attachment structure of a holder case and a bus bar taken along the line VI-VI of FIG. 4.

FIG. 7 illustrates a cross-sectional view showing a structure in which a bus bar is coupled and fixed to a protrusion of a holder case taken along the line VII-VII of FIG. 4.

FIG. 8 illustrates a cross-sectional view showing structures of a holder case and a bus bar applied to a rechargeable battery module according to another embodiment of the present disclosure.

FIG. 9 illustrates a top plan view of the rechargeable battery module shown in FIG. 1 showing battery cells connected in series and parallel with a bus bar.

FIG. 10 illustrates a top plan view of a rechargeable battery module showing battery cells connected in series and parallel with a bus bar according to another embodiment of the present disclosure.

FIG. 11 illustrates a top plan view of a rechargeable battery module showing battery cells connected in series and parallel with a bus bar according to another embodiment of the present disclosure.

### DETAILED DESCRIPTION

Hereinafter, the present disclosure will be described more fully with reference to the accompanying drawings, in which embodiments thereof are shown. As those skilled in the art would realize, the described embodiments may be modified in various different ways, all without departing from the spirit or scope of the present disclosure. Thus, the drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

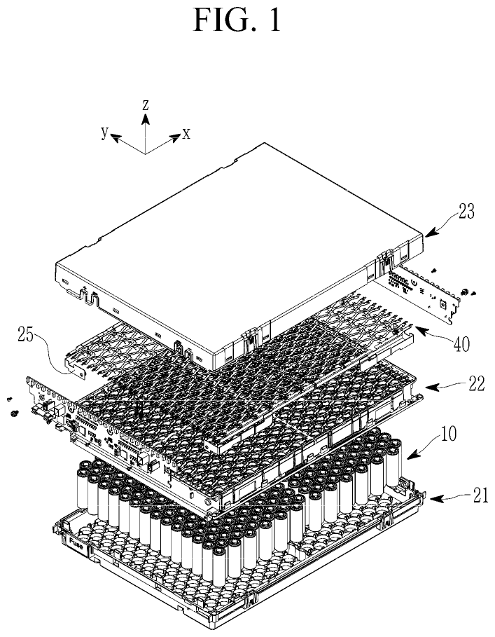

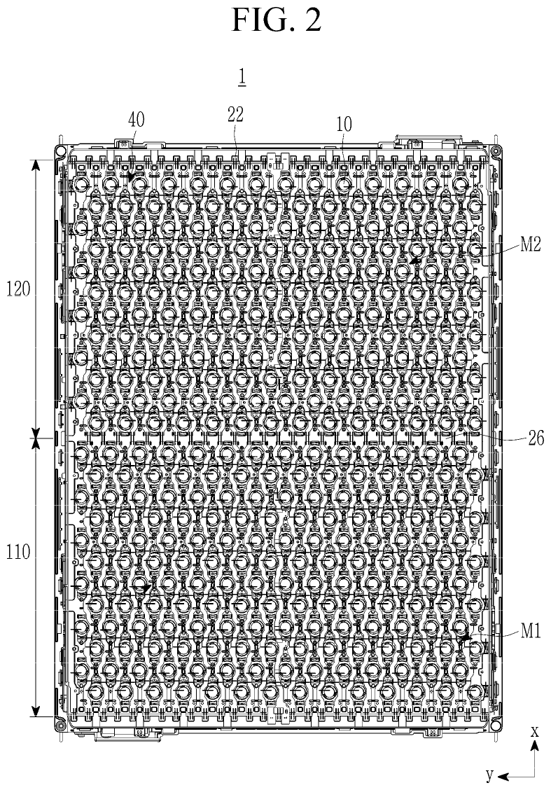

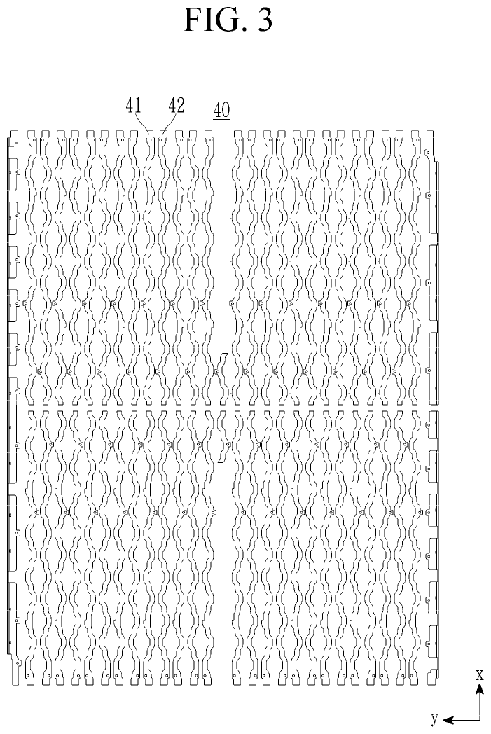

FIG. 1 illustrates an exploded perspective view of a rechargeable battery module according to an embodiment of the present disclosure, FIG. 2 illustrates a top plan view of the rechargeable battery module shown in FIG. 1 in which bus bars are installed in battery cells, and FIG. 3 illustrates a top plan view of the rechargeable battery module of FIG. 1 showing the bus bars.

Referring to FIG. 1 to FIG. 3, the rechargeable battery module 1, according to an embodiment of the present disclosure, includes a plurality of battery cells 10, a lower case 21, a holder case 22, bus bars 40, bonding wires 50, and an upper case 23.

The battery cells 10 are formed as cylindrical rechargeable batteries and are accommodated in the lower case 21 and the holder case 22, which are coupled to each other. The lower case 21 accommodates lower sides (or lower ends) and lower portions of the battery cells 10, and the holder case 22 is coupled to the lower case 21 and accommodates upper sides (or upper ends) and upper portions of the battery cells 10.

The upper case 23 is positioned on the holder case 22 to be coupled thereto. The bus bars 40 are positioned on and coupled to the holder case 22. In the illustrated embodiment, an intermediate medium member 25 is provided between the holder case 22 and the upper case 23. The intermediate medium member 25 is positioned on a side surface of the holder case 22 to enable the holder case 22 and the upper case 23 to be securely coupled at insides and outsides thereof.

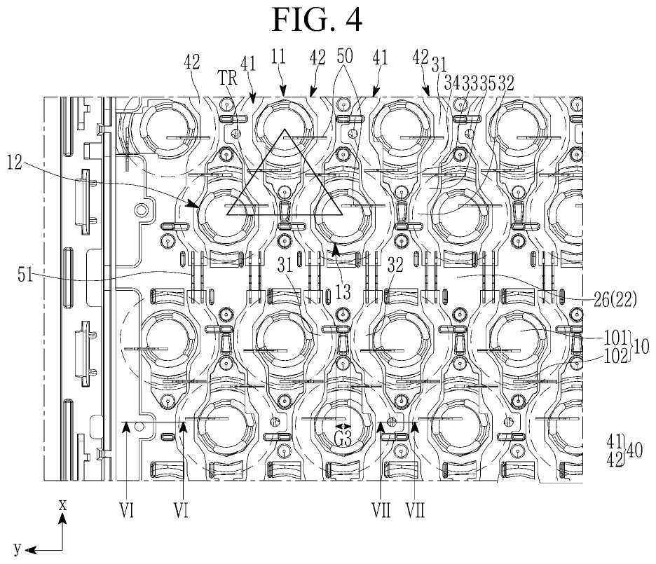

FIG. 4 illustrates a partial top plan view of the rechargeable battery module shown in FIG. 2 in which the bus bars are installed in (or on) the battery cells. Referring to FIG. 4, the bonding wires 50 respectively connect the battery cells 10 to the bus bars 40. The battery cells 10 include a positive terminal 101 and a negative case (e.g., the case or can acting as a negative terminal) 102 at a side of the holder case 22. The positive terminal 101 and the negative case 102 are provided at a same side of the battery cells 10. In other embodiments, the terminal 101 may be a negative electrode, and the case 102 may be a positive electrode.

The battery cells 10 are connected, via the bonding wires 50, to the bus bars 40 to implement a plurality of serial connections and a plurality of parallel connections. Accordingly, the rechargeable battery module 1 may implement (or may provide) various voltages and various currents.

For example, the bonding wires 50 respectively wire-bond the positive terminal 101 and the negative case 102 of the battery cells 10 to the bus bars 40. Accordingly, the battery cells 10 are connected in parallel in a first direction (e.g., the x-axis direction), and the battery cells 10 are connected in parallel in a second direction (e.g., the y-axis direction) crossing the first direction.

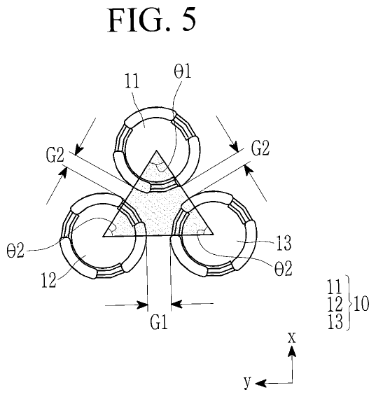

FIG. 5 illustrates a top plan view geometrically showing a disposition relationship of the battery cells shown in FIG. 4. Referring to FIG. 4 and FIG. 5, three adjacent battery cells 10 form an isosceles triangular arrangement (TR). Further, each battery cell 10 of the isosceles triangular arrangement (TR) forms a different isosceles triangular arrangement (TR) with another two battery cells 10 adjacent thereto.

The three adjacent battery cells 10 of one isosceles triangular arrangement (TR) include a first battery cell 11, a second battery cell 12, and a third battery cell 13. The first battery cell 11 forms a first angle θ1 of the isosceles triangle, and the second battery cell 12 and the third battery cell 13 form remaining second angles θ2 and θ2 of the isosceles triangle.

The holder case 22 may be formed to have a quadrangular or square shape as illustrated in, for example, FIG. 2. In another embodiment in which the holder case 22 has the square shape, a first angle θ1 of the isosceles triangular arrangement (TR) is about 68° and a second angle θ2 is smaller than the first angle θ1 and is about 56°. The second battery cell 12 and the third battery cell 13, which face each other according to the first angle θ1 of the first battery cell 11, have a first gap G1 therebetween.

The first battery cell 11 and the second battery cell 12 have a second gap G2 therebetween, which is smaller than the first gap G1. The first battery cell 11 and the third battery cell 13 have the second gap G2 therebetween. In addition, the first gap G1 may be about 3.6 mm, and the second gap G2 may be about 1.0 mm.

Referring back to FIG. 2 to FIG. 4, the bus bar 40 includes a first member 41 and a second member 42. The battery cells 10 having the isosceles triangular arrangement (TR) will be described as an example. Each battery cell 10 of the isosceles triangular arrangement (TR) forms a different isosceles triangular arrangement (TR) with the other two battery cells 10 adjacent thereto.

The first member 41 extends along the first direction (e.g., the x-axis direction) and is positioned between the first battery cell 11 and the second battery cell 12. The second member 42 extends along the first direction and is positioned between the first battery cell 11 and the third battery cell 13.

In addition, the first member 41 and the second member 42 are positioned at (e.g., extend around or along) opposite sides of the first battery cell 11 in the second direction (e.g., the y-axis direction) and are spaced apart from each other in the second direction between the second battery cell 12 and the third battery cell 13.

The first, second, and third battery cells 11, 12, and 13 form the isosceles triangular arrangement (TR). The first battery cell 11 forms one isosceles triangular arrangement (TR) with the other two battery cells 10 adjacent thereto. The second battery cell 12 forms another isosceles triangular arrangement (TR) with another two battery cells 10 adjacent thereto. The third battery cell 13 forms another isosceles triangular arrangement (TR) with yet another two battery cells 10 adjacent thereto.

Positions of the first, second, and third battery cells 11, 12, and 13, which form the three isosceles triangular arrangements (TR) occupy different positions of the different isosceles triangular arrangement (TR).

The bus bar 40 has a structure in which the first member 41 and the second member 42 are repeatedly positioned (e.g., are repeatedly, alternatingly arranged) in the second direction except for the outermost ones. The first member 41 and the second member 42 form a left-right symmetrical structure in the second direction with a center line therebetween extending in the first direction.

A specific structure of the first member 41 and the second member 42, according to an embodiment of the present disclosure, will be described. Because the first member 41 and the second member 42 have symmetrical structures, the second member 42 will be described as an example. The second member 42 includes a first straight portion 31, a second straight portion 32, a third straight portion 33, a first inclined portion 34, and a second inclined portion 35.

The first straight portion 31 extends from opposite sides of the first battery cell 11 in the first direction (e.g., the x-axis direction). The second straight portion 32 extends between the second battery cell 12 and the third battery cell 13 in the first direction. The third straight portion 33 extends between the first battery cell 11 and the second battery cell 12 and between the first battery cell 11 and the third battery cell 13 in the first direction.

The first inclined portion 34 obliquely connects (e.g., extends between) the first straight portion 31 and the third straight portion 33. The second inclined portion 35 obliquely connects (e.g., extends between) the second straight portion 32 and the third straight portion 33.

As an example, the bus bar 40 may be formed of an aluminum alloy (e.g., AA2024 or duralumin, an alloy including 90% to 94% aluminum, 4% copper, 1% magnesium, and 0.5% to 1% manganese) and may have a thickness of about 0.5 mm and a width of about 4.0 mm. The second straight portion 32 of the first member 41 and the first straight portion 31 of the second member 42 have a minimum third gap G3.

In one embodiment, the third gap G3 may have a minimum of about 1.5 mm to provide for creepage clearance. The third gap G3 is smaller than the first gap G1 and greater than the second gap G2. Thus, in one embodiment, the first gap G1 is about 3.6 mm, and the second gap G2 is about 1.0 mm.

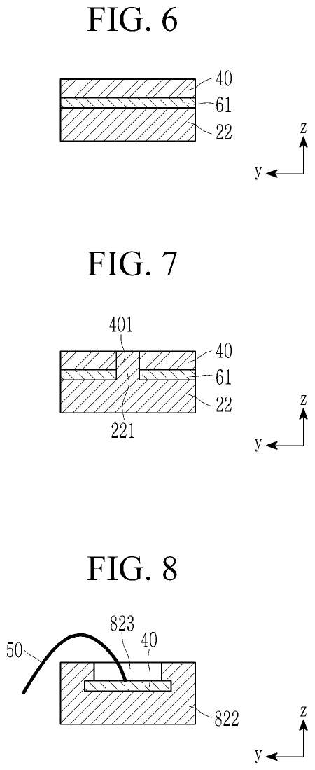

FIG. 6 illustrates a cross-sectional view showing an attachment structure of the holder case and the bus bar taken along the line VI-VI of FIG. 4. Referring to FIG. 4 and FIG. 6, the bus bar 40 may be fixed on the holder case 22 by a double-sided tape 61 provided therebetween. The double-sided tape 61 prevents the pre-installed bus bars 40 from being displaced during an installation process of a large number of bus bars 40.

FIG. 7 illustrates a cross-sectional view showing a structure in which the bus bar is coupled and fixed to a protrusion of the holder case taken along line the VII-VII of FIG. 4. Referring to FIG. 4 and FIG. 7, the bus bar 40 is coupled to a protrusion 221 of the holder case 22 through a hole (e.g., an opening) 401 in the bus bar 40 to be fixed thereto. Due to the coupling between the protrusion 221 and the hole 401, the pre-installed bus bars 40 are not displaced during an installation process of a large number of bus bars 40.

The attachment structure of the double-sided adhesive tape 61 and the coupling structure of the protrusion 221 and the hole 401 may be used exclusively or may be used together. When both of the structures are applied (see, e.g., FIG. 7), a fixing structure of the bus bar 40 may be further strengthened.

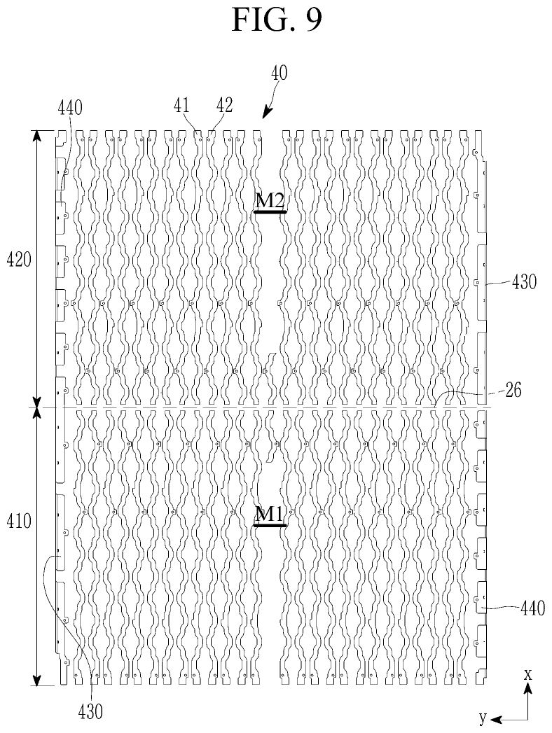

FIG. 8 illustrates a cross-sectional view showing structures of a holder case and a bus bar applied to a rechargeable battery module according to another embodiment of the present disclosure. Referring to FIG. 8, the bus bar 40 may be fixed to the holder case 822 by insert molding.

In such an embodiment, the holder case 822 has an opening 823 in an upper side enabling access for the bonding wire 50 to be wire-bonded to the bus bar 40 through the opening 823. Because the holder case 822 having an insert molding structure of the bus bar 40 eliminates an installation process of the bus bar 40, a separate handling process of the bus bar 40 can be omitted.

Hereinafter, rechargeable battery modules capable of implementing various requirements for voltage and current according to a module with the same design are exemplified through various examples of a holder case having a length of a bus bar and a partition wall corresponding thereto.

FIG. 9 illustrates a top plan view of a rechargeable battery module shown in FIG. 2 to FIG. 4 showing battery cells connected in series and parallel with a bus bar. Referring to FIG. 2 to FIG. 4 and FIG. 9, the holder case 22 includes at least one partition wall 26 extending in the second direction to divide the holder case 22 into a plurality of (e.g., two) sections in the first direction.

At least two bus bars 40 are positioned at opposite sides of the partition wall 26 along the first direction. The two bus bars 40 are connected by a bonding wire (e.g., a bus bar bonding wire) 51 (see, e.g., FIG. 4) positioned on the partition wall 26.

The partition wall 26 divides the battery cells 10 into a first cell area 110 and a second cell area 120 along the first direction (x-axis direction). The bus bar 40 includes a first area member 410 connecting the battery cells 10 in the first cell area 110 to each other and a second area member 420 connecting the battery cells 10 in the second cell area 120 to each other. In addition, the bus bar 40 further includes a first outer member 430 and a second outer member 440 at an outer side to enable serial and parallel connections.

The battery cells 10 form a first module M1 by a plurality of first serial connections and a plurality of second parallel connections between the first cell area 110 and the first area member 410. In addition, the battery cells 10 form a second module M2 by a plurality of first serial connections and a plurality of second parallel connections between the second cell area 120 and the second area member 420.

The battery cells 10 form the rechargeable battery module 1 by a plurality of first double serial connections and a plurality of second parallel connections by wire bonding the first area member 410 and the second area member 420 with the bonding wire 51 (see, e.g., FIG. 4). When the wire bonding is not performed (e.g., when the bonding wire 51 is omitted), the first and second modules M1 and M2 are driven separately, and thus, voltage and current specifications different from those when the wire bonding is performed may be implemented.

For example, in the first cell area 110, the battery cells 10 form the first module M1 having a 28s6p configuration including 28 serial connections (s) and 6 parallel connections (p) by the first area member 410. In addition, in the second cell area 120, the battery cells 10 form the second module M2 having a 28s6p configuration including 28 serial connections (s) and 6 parallel connections (p) by the second area member 420.

In addition, the battery cells 10 form the rechargeable battery module 1 having a 56s6p connection configuration by connecting the first and second modules M1 and M2 by connecting the first and second area members 410 and 420 by the bonding wire 51.

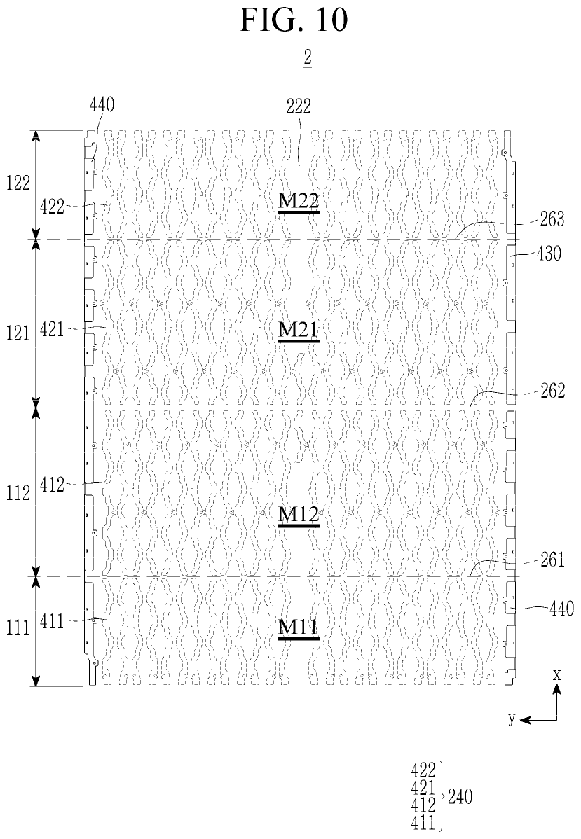

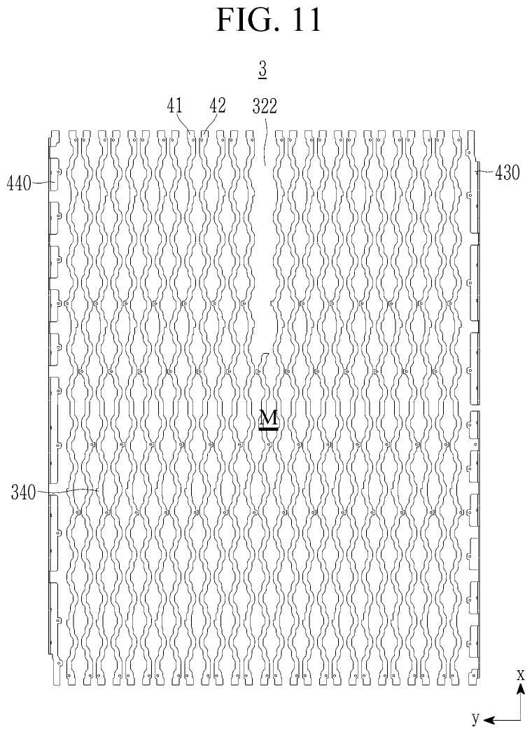

FIG. 10 illustrates a top plan view of a rechargeable battery module according to another embodiment of the present disclosure showing battery cells connected in series and parallel with a bus bar. Referring to FIG. 10, in the rechargeable battery module 2, the holder case 222 includes three partition walls 261, 262, and 263 extending in the second direction to divide the holder case 222 into four sections in the first direction.

Four bus bars 240 (411, 412, 421, and 422) positioned at opposite sides of partition walls 261, 262, and 263 (e.g., positioned in different sections of the holder case 222) are connected by bonding wires 51 (see, e.g., FIG. 4) positioned on the partition walls 261, 262, and 263.

The partition walls 261, 262, and 263 divide the battery cells 10 into first, second, third, and fourth cell areas 111, 112, 121, and 122 along the first direction (e.g., the x-axis direction). The battery cells 10 are positioned as in FIG. 1 and FIG. 2.

Accordingly, the bus bars 240 (411, 412, 421, and 422) include first, second, third, and fourth area members 411, 412, 421, and 422 respectively connecting the battery cells 10 of the first, second, third, and fourth cell areas 111, 112, 121, and 122. In addition, the bus bar 40 further includes a first outer member 430 and a second outer member 440 at an outer side to enable serial and parallel connections.

The battery cells 10 respectively form first, second, third, and third modules M11, M12, M21, and M22, and the battery cells in each of the first, second, third, and third modules M11, M12, M21, and M22 have a 28s3p connection configuration by a plurality of first serial connections and a plurality of second parallel connections from the first, second, third, and fourth cell areas 111, 112, 121, and 122 to the first, second, third, and fourth area members 411, 412, 421, and 422.

In addition, the battery cells 10 form the rechargeable battery module 2 having a 112s3p connection configuration by connecting the first, second, third, and fourth modules M11, M12, M21, and M22, by the first, second, third and fourth area members 411, 412, 421 and 422, by the bonding wire 51.

When the wire bonding is not performed (e.g., when the bonding wire 51 is omitted), the first, second, third, and fourth modules M11, M12, M21, and M22 are separately driven, and thus, voltage and current specifications different from those when wire bonding is performed may be implemented.

FIG. 11 illustrates a top plan view of a rechargeable battery module according to another embodiment of the present disclosure showing battery cells connected in series and parallel with a bus bar. Referring to FIG. 11, in the rechargeable battery module 3, a holder case 322 is formed as a single case (e.g., has a single section M) along the first direction. Therefore, because a bus bar 340 is formed as a single bar along the first direction, a bonding wire is not required.

The battery cells 10 form one module M having a 28s12p connection configuration by a plurality of serial connections and a plurality of parallel connections to one bus bar 340 in one cell area.

It will be understood that, when 336 battery cells 10 are included, the battery cells 10 may form various rechargeable battery modules according to different connections between the bus bars 40, 240, 340 and the first and second outer members 430 and 440 by the bonding wires 51. When the rechargeable battery module that can be included in the present disclosure has 336 battery cells, bonding wires may be formed in various ways according to connection of the bus bars.

For example, a rechargeable battery module including 336 battery cells may be a 1s336p module formed by 336 parallel connections, a 2s168p module formed by two serial connections and 168 parallel connections, a 3s112p module formed by three serial connections and 112 parallel connections, a 6s56p module formed by six serial connections and 56 parallel connections, and a 12s28p module formed by 12 serial connections and 28 parallel connections.

In addition, a rechargeable battery module including 336 battery cells may be a 28s12p module formed by 28 serial connections and 12 parallel connections, a 56s6p module formed by 56 serial connections and six parallel connections, a 112s3p module formed by 112 serial connections and three parallel connections, a 168s2p module formed by 168 serial connections and two parallel connections, and a 336s1p module formed by 366 serial connections.

While the present disclosure has been described in connection with what is presently considered to be practical embodiments, it is to be understood that the present disclosure is not limited to the disclosed embodiments. On the contrary, the present disclosure covers various modifications and equivalent arrangements included within the spirit and scope of the appended claims and their equivalents.

Description of Some Reference Symbols

| | |
|---|---|
| 1, 2, 3: rechargeable battery | 10: battery cell |
| module | |
| 11: first battery cell | 12: second battery cell |
| 13: third battery cell | 21: lower case |
| 22: holder case | 23: upper case |
| 25: intermediate medium member | 26: cell barrier |
| 31: first straight portion | 32: second straight portion |
| 33: third straight portion | 34: first inclined portion |
| 35: second inclined portion | 40: bus bar |
| 41: first member | 42: second member |
| 50: bonding wire | 51: bonding wire (e.g., bus bar |
| | bonding wire) |
| 61: double-sided adhesive tape | 101: positive terminal |
| 102: negative electrode case | 110, 120: first, second cell area |
| 111, 112, 121, 122: first, second, | |
| third, fourth cell area | |
| 221: protrusion | 240, 340: bus bar |
| 261, 262, 263: cell barrier | 322: holder case |
| 401: hole | 410, 411: first area member |
| 412, 420: second area member | 421, 422: third, fourth area member |
| 430: first outer member | 440: second outer member |
| 822: holder case | 823: opening |
| G1: first gap | G2: second gap |
| G3: third gap | M: module |
| M1: first module | M2: second module |
| M11, M12, M21, M22: first, | |
| second, third, fourth module | |
| TR: isosceles triangle arrangement | θ1: first angle |
| θ2: second angle | |

What is claimed is:

1. A rechargeable battery module comprising:
a plurality of battery cells;
a lower case accommodating lower ends of the battery cells;
a holder case coupled to the lower case and accommodating the battery cells;
a plurality of bus bars on the holder case;
a plurality of bonding wires connecting the battery cells to the bus bars; and
an upper case covering the bus bars and the bonding wires and coupled to the holder case.

2. The rechargeable battery module as claimed in claim 1, wherein the bus bars connect the battery cells through a plurality of serial connections and a plurality of parallel connections.

3. The rechargeable battery module as claimed in claim 1, wherein the battery cells have a cylindrical shape, and
wherein three adjacent ones of the battery cells accommodated in the holder case form an isosceles triangular arrangement.

4. The rechargeable battery module as claimed in claim 3, wherein a side of a first battery cell from among the three adjacent ones of the battery cells forms a first angle of 68° in the isosceles triangular arrangement, and
wherein sides of a second battery cell and a third battery cell from among the three adjacent ones of the battery cells each form a second angle of 56° in the isosceles triangular arrangement.

5. The rechargeable battery module as claimed in claim 3, wherein a second battery cell and a third battery cell from among the three adjacent ones of the battery cells face each other at a first angle at a side of a first battery cell from among the three adjacent ones of the battery cells and have a first gap therebetween,
wherein the first battery cell and the second battery cell have a second gap therebetween that is smaller than the first gap, and
wherein the first battery cell and the third battery cell have the second gap therebetween.

6. The rechargeable battery module as claimed in claim 5, wherein the bus bars comprise:
a first member between the first battery cell and the second battery cell and extending along a first direction; and
a second member between the first battery cell and the third battery cell and extending along the first direction.

7. The rechargeable battery module as claimed in claim 6, wherein the first member and the second member are respectively at opposite sides of the first battery cell and are spaced apart in a second direction crossing the first direction, and
wherein the first member and the second member are between the second battery cell and the third battery cell.

8. The rechargeable battery module as claimed in claim 6, wherein the first member and the second member each have:
a first straight portion extending in the first direction from opposite sides of the first battery cell;
a second straight portion extending in the first direction between the second battery cell and the third battery cell;
a third straight portion extending in the first direction between the first battery cell and the second battery cell and between the first battery cell and the third battery cell;
a first inclined portion connecting the first straight portion and the third straight portion; and
a second inclined portion connecting the second straight portion and the third straight portion.

9. The rechargeable battery module as claimed in claim 8, wherein the bus bar is an aluminum alloy and has a thickness of 0.5 mm and a width of 4.0 mm.

10. The rechargeable battery module as claimed in claim 8, wherein the second straight portion of the first member and the second straight portion of the second member have a third gap therebetween.

11. The rechargeable battery module as claimed in claim 10, wherein the third gap is smaller than the first gap and greater than the second gap.

12. The rechargeable battery module as claimed in claim 1, wherein the bus bars are fixed on the holder case by a double-sided adhesive tape.

13. The rechargeable battery module as claimed in claim 1, wherein the holder case has a protrusion extending into a hole in the bus bars to fix the bus bars to the holder case.

14. The rechargeable battery module as claimed in claim 1, wherein the bus bars are fixed to the holder case by insert molding.

15. The rechargeable battery module as claimed in claim 1, wherein the holder case comprises a partition wall extending in a second direction crossing a first direction to divide the holder case into a plurality of sections in the first direction, and
wherein at least two of the bus bars at opposite sides of the partition wall along the first direction are connected to each other by a bus bar bonding wire on the partition wall.

16. The rechargeable battery module as claimed in claim 15, wherein the partition wall divides the battery cells into a first cell area and a second cell area along the first direction, and
wherein the bus bars each comprises a first area member connecting the battery cells in the first cell area to each other and a second area member connecting the battery cells in the second cell area to each other.

17. The rechargeable battery module as claimed in claim 16, wherein the bus bar bonding wire wire bonds the first area member and the second area member.

18. The rechargeable battery module as claimed in claim 16, wherein the battery cells:
form a first module comprising a plurality of first serial connection groups and a plurality of second parallel groups with the first area member in the first cell area;
form a second module comprising a plurality of first serial connection groups and a plurality of second parallel groups with the second area member in the second cell area; and
form a module comprising a plurality of first double serial connections and a plurality of second parallel connections by wire bonding the first area member and the second area member with the bus bar bonding wire.

19. The rechargeable battery module as claimed in claim 16, wherein the battery cells:
form a first module having a 28s6p connection configuration by connecting 28 serial connection groups using 6 parallel groups with the first area member in the first cell area;
form a second module having a 28s6p connection configuration by connecting 28 serial connection groups using 6 parallel groups with the second area member in the second cell area; and
form a module having a 56s6p by wire bonding the first area member and the second area member with the bus bar bonding wire.

20. The rechargeable battery module as claimed in claim 1, wherein the holder case comprises three partition walls extending in a second direction crossing a first direction to divide the holder case into four sections in the first direction, and
wherein four of the bus bars are respectively in the four section at opposite sides of the three partition walls and are connected by bus bar bonding wires on the partition walls.

21. The rechargeable battery module as claimed in claim 1, wherein a number of the battery cells is 336, and
wherein the bonding wires and the bus bar bonding wire connect the battery cells to form one of:
a 1s336p module formed by 336 parallel connections;
a 2s168p module formed by two serial connections and 168 parallel connections;
a 3s112p module formed by 3 serial connections and 112 parallel connections;
a 6s56p module formed by 6 serial connections and 56 parallel connections;
a 12s28p module formed by 12 serial connections and 28 parallel connections;
1 a 28s12p module formed by 28 serial connections and 12 parallel connections;
a 56s6p module formed by 56 serial connections and 6 parallel connections;
a 112s3p module formed by 112 serial connections and 3 parallel connections;
a 168s2p module formed by 168 serial connections and 2 parallel connections; and
a 336s1p modules formed by 366 serial connections.
